(19) United States
(12) Patent Application Publication
(10) Pub. No.: US 2026/0339913 A1
(43) Pub. Date: Oct. 29, 2026

(54) DATA RETRIEVAL USING VECTOR DATABASES AT A MEMORY SYSTEM

(71) Applicant: Micron Technology, Inc., Boise, ID (US)

(72) Inventors: Vamsi Pavan Rayaprolu, Santa Clara, CA (US); Aswin Thiruvengadam, El Dorado Hills, CA (US)

(21) Appl. No.: 19/192,274

(22) Filed: Apr. 28, 2025

(51) Int. Cl. G06F 16/22; G06F 16/245; G06F 16/2453

(52) U.S. Cl. CPC G06F 16/2237; G06F 16/24532; G06F 16/24569

(57) ABSTRACT

Methods, systems, and devices for data retrieval using vector databases at a memory system are described. A system may support methods or architectures that enable more-efficient access operations, search operations, and data retrieval operations associated with relatively large databases stored at the system. To reduce communication overhead, database navigation and data retrieval operations may be performed directly within a memory system. The memory system may be structured to support enhanced parallelism across multiple memory devices of the system, enabling concurrent search operations. The memory system may include a central controller that is operable to couple with respective memory controllers of multiple memory devices via respective channels. The central controller may receive a query and may communicate with the memory controllers to identify and output corresponding data in response to the input query.

### TECHNICAL FIELD

The following relates to one or more systems for memory, including data retrieval using vector databases at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data retrieval using vector databases at a memory system in accordance with examples as disclosed herein.

FIG. 2 shows an example of a database that supports data retrieval using vector databases at a memory system in accordance with examples as disclosed herein.

FIG. 3 shows an example of a system that supports data retrieval using vector databases at a memory system in accordance with examples as disclosed herein.

FIG. 4 shows a block diagram of a memory system that supports data retrieval using vector databases at a memory system in accordance with examples as disclosed herein.

FIG. 5 shows a flowchart illustrating a method or methods that support data retrieval using vector databases at a memory system in accordance with examples as disclosed herein.

### DETAILED DESCRIPTION

Some memory systems may store data that supports various artificial intelligence (AI) or machine learning (ML) applications (e.g., AI/ML applications). For instance, an application may receive a request for data (e.g., a query input, from a user) and may utilize one or more AI/ML algorithms to search (e.g., access, navigate) a database stored at the memory system to identify and output corresponding data in response to the request. Such databases may store relatively large and complex (e.g., unorganized, unstructured) datasets, such that navigating the database may be relatively time-consuming and resource-intensive. An example of such a database may be a vector database, which may store a set of embedding vectors (e.g., numerical representations of a set of data, such as an image, an audio signal, a string of text, or other data) in a vector space. In some cases, embedding vectors that are relatively similar (e.g., a vector representing a string, “object A”, and a vector representing an image of the object A) may be located relatively closer to each other in the vector space than embedding vectors that are relatively different from one another (e.g., the vector representing a string, “object A”, and a vector representing an image of an object B).

Some memory system architectures and data access methods may not be configured to support such databases efficiently, particularly as the size and complexity of the datasets increases. For instance, some architectures and methods may be based on processing at a host system (e.g., an external processor, for search operations, distance computations, and other operations) and active communications between the memory system and the host system (e.g., commands, data transfer, and other signaling). As database complexity increases, such techniques may result in relatively high latency, relatively high resource consumption, and other inefficiencies (e.g., as a result of a processing bottleneck at the host system and communication overhead between devices).

In accordance with examples as disclosed herein, a system (e.g., a memory system, a not-and (NAND) system, a solid-state drive (SSD), an electronic system) may support techniques (e.g., methods, architectures, or a combination thereof) that enable more-efficient access operations, search operations, and data retrieval operations associated with a database (e.g., a vector database) stored at the system. For example, database navigation (e.g., embedding vector search) and data retrieval operations may be performed within a memory system, thereby reducing communication overhead (e.g., with a host system). Additionally, or alternatively, the memory system may be structured to support enhanced parallelism across multiple memory devices of the system (e.g., in accordance with a parallel vector search operation). In some examples, the memory system may include a central controller (e.g., a front end (FE) core processor) that is operable to couple with respective memory controllers (e.g., embedded memory (EM) cores, local controllers) of multiple memory devices (e.g., NAND devices) via respective channels.

During a database access operation, the central controller may receive (e.g., from a user, via a host system) a query (e.g., an input query, a query vector, a user request to retrieve data, a user query) and may communicate with the memory controllers (e.g., in parallel) to identify and output corresponding data in response to the query. In some examples, a computational capability (e.g., a floating point unit (FPU)) of the memory controllers may be leveraged to perform various database search operations (e.g., calculations, distance calculations, comparisons). Additionally, neighboring embedding vectors of a vector space may be stored across different (e.g., parallel) memory devices, which may enable faster database search operations (e.g., in a nearest neighbor search algorithm). Accordingly, such techniques may simplify data management of relatively large databases (e.g., vector databases, unstructured databases, and other AI/ML application databases), reducing the complexity and processing overhead (e.g., associated with handling high-dimensional vector embeddings). Moreover, such architectures may enable more efficient and scalable database systems, which may support AI/ML applications and other data intensive applications that benefit from fast and accurate retrieval of data (e.g., semantically similar data in response to a query).

In addition to applicability in memory systems as described herein, techniques for data retrieval using vector databases at a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enhancing parallelism and improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of databases and flowcharts.

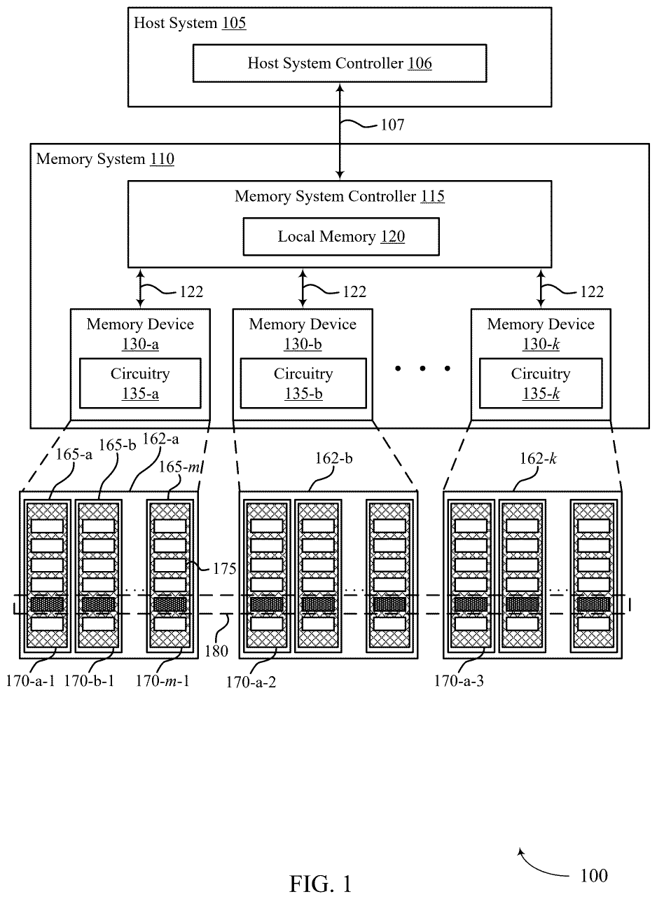

FIG. 1 shows an example of a system 100 that supports data retrieval using vector databases at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-k, where k represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, or ONFI interfaces, among others. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-k may include circuitry 135-k.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include m planes 165 and each plane may include n blocks 170 (e.g., with the example of FIG. 1 illustrating one block 170 per plane 165), where m and n represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-m, where m represents an Mth plane. The memory die 162-b and the memory die 162-k may also include M planes. In some cases, an individual block 170 may be referred to as a physical block, and a virtual block 180 may refer to a group of blocks 170 within which concurrent operations may occur. A virtual block 180 may be a logical structure that includes a plurality of blocks 170, and different blocks 170 of the plurality of blocks 170 may come from different planes 165 or different memory dies 162. In some cases, a virtual block 180 may include blocks 170 from different memory devices 130 (e.g., including blocks in one or more planes 165 of memory device 130-a, memory device 130-b, and memory device 130-k). In some examples, a virtual block 180 may include a respective block 170 from each plane 165 (e.g., a block 170 from each plane 165) of one or more memory dies 162.

In some cases, the blocks 170 within a virtual block 180 may have the same block address within their respective planes 165. For example, block 170-a-1 may be “block 0” of a first plane 165 of die 162-a, block 170-a-2 may be “block 0” of a first plane 165 of die 162-b, block 170-a-3 may be “block 0” of a first plane 165 of die 162-k, and so on. By way of further example, block 170-b-1 may be “block 1” of a first plane 165 of die 162-a and block 170-m-1 may be “block m-1” of die 162-a, where m represents an Mth block. The memory die 162-b and the memory die 162-k may also include M blocks 170. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

Some systems (e.g., memory systems 110) may store data that supports various AI/ML applications, and such data may be organized into a database. Databases that support AI/ML applications may store relatively large and complex (e.g., unorganized, unstructured) datasets, such that navigating the database may be relatively time-consuming and resource-intensive. However, some data access methods and architectures for a memory system 110 and may not efficiently support navigating and performing other operations associated with the database. For instance, some techniques may be based on processing by a host system 105 (e.g., for search operations, distance computations, and other operations) and signaling between the host system 105 and a memory system 110 (e.g., commands, data transfer, and other signaling). As database complexity increases, such techniques may result in relatively high latency, relatively high resource consumption, and other inefficiencies in a system 100.

In accordance with examples as disclosed herein, a system 100 may be configured to support techniques (e.g., methods, architectures, or a combination thereof) that enable more-efficient access operations, search operations, and data retrieval operations associated with a database (e.g., a vector database) stored at the system 100 (e.g., stored at one or more memory devices 130 of the memory system 110). For example, a memory system 110 (e.g., a memory system controller 115, circuitry 135, or a combination thereof) may be configured to directly perform database navigation operations (e.g., vector searches, vector comparisons) and data retrieval operations (e.g., without involvement of the host system 105), thereby reducing communication overhead. Additionally, or alternatively, a memory system 110 may be structured to support enhanced parallelism across multiple memory devices 130. In some examples, a memory system 110 may include a central controller (e.g., an FE core, a memory system controller 115) that is operable to couple with respective memory controllers (e.g., EM cores, local memory controllers, circuitry 135) of one or more memory devices 130 (e.g., NAND devices) via respective channels (e.g., respective interfaces 122).

During a database access or search operation, the central controller may receive (e.g., from a user, from a host system 105) a query (e.g., an input query, a query vector, a user request to retrieve data, a user query) and may communicate with the memory controllers (e.g., in parallel) to identify and output corresponding data in response to the query. In some examples, a computational capability (e.g., of circuitry 135, such as an FPU) of the memory controllers may be leveraged to perform various database search operations (e.g., calculations, distance calculations, comparisons). Accordingly, such techniques may simplify data management of relatively large databases (e.g., vector databases, unstructured databases, and other AI/ML application databases), reducing the complexity and processing overhead (e.g., associated with handling high-dimensional vector embeddings). Moreover, such architectures may enable more efficient and scalable database systems stored at a system 100, which may support AI/ML applications and other data intensive applications that benefit from fast and accurate retrieval of data.

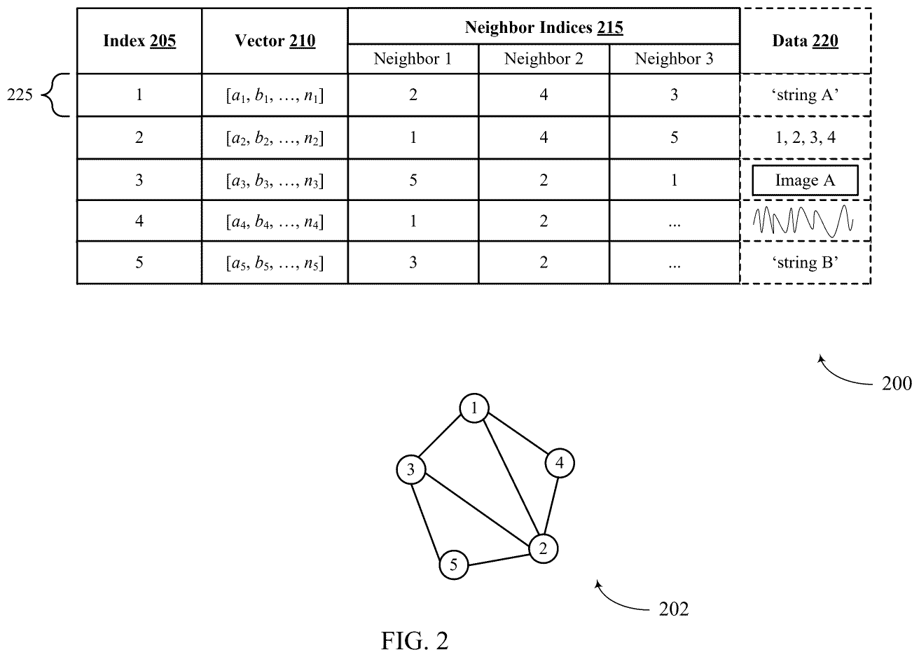

FIG. 2 shows an example of a database 200 that supports data retrieval using vector databases at a memory system in accordance with examples as disclosed herein. In some cases, a memory system 110 may store one or more portions of the database 200 at one or more memory devices (e.g., memory devices 130).

A memory system 110 may store data with various levels (e.g., classes, categories, degrees) of structure. For instance, a memory system 110 may store “structured” data, which may refer to data that is organized in a predefined manner (e.g., data that fits a tabular format, where fields, such as columns and rows, may be decided ahead of time, relational databases). Additionally, or alternatively, a memory system 110 may store “semi-structured” data, which may refer to data that may be fit to a tabular format but new fields may be added to separate semantic elements (e.g., non-relational databases, such a not only structured query language (noSQL) databases). Additionally, or alternatively, a memory system 110 may store “unstructured” data, which may refer to data that lacks a predefined format or organizational structure. This type of data may be free-form and may not conform to some database structures (e.g., may not fit into a row-and-column structure). Unstructured data may include a relatively wide variety of content types, such as sensor data, IoT data, text documents, emails, social media posts, images, audio recordings, and videos. Both structured data and semi-structured data may be relatively simple to navigate, access, and manage. However, relatively more complex and sophisticated methods may be used for managing and retrieving unstructured data (e.g., vector databases and machine learning algorithms) to extract meaningful information (e.g., a relationship between requested data and stored data).

Some implementations of unstructured data may present various challenges to memory systems. For instance, a system may be responsible for determining a relevance associated with queries (e.g., requests) for data retrieval. In some cases, various algorithms may be configured to convert a query to a numerical representation, which may be an embedding vector (e.g., a row vector with some quantity of row elements). An “embedding vector” may refer to a vector that includes some quantity of dimensions, where each element (e.g., dimension) in the vector may capture a specific feature or characteristic of the data. In some examples, one or more algorithms may be used to perform vector embeddings (e.g., hashing algorithms, such as MinHash, deep networks, such as a convolutional neural network (CNN), multimodal models, such as transformers). Accordingly, embedding vectors may carry semantic content and may thus be used to retrieve cross-data content (e.g., across different modes of data, such as both images and text). For example, embedding vectors may enable retrieval of an image based on a text query, or retrieval of text from an image query, among other examples.

In some examples, unstructured data may present challenges in searching, indexing, and processing the data. In some cases, a system may manage such challenges by implementing a vector database, such as the database 200. A “vector database” may refer to a database system designed to store, index, and search in accordance with vector embeddings (e.g., high-dimensional vector embeddings). Such embeddings may be numerical representations of data objects that capture the semantic content of the data. In the example of FIG. 2, a database 200 (e.g., a vector database) may include one or more entries 225 (e.g., rows). Each entry 225 may include (e.g., be associated with) various elements, including, for example, an index 205 (e.g., a row index), a vector 210 (e.g., an embedding vector), one or more neighbor indices 215, and data 220 (e.g., which may optionally be stored to memory devices along with the other elements of the database, or may be stored at location separate from the other elements). Unlike some relational databases (e.g., with rows and columns for the data storage), data points in the database 200 may represented by vectors 210 with a quantity (e.g., a fixed quantity, a quantity, n, which may be any integer quantity) of dimensions clustered based on similarity.

In some cases, the vectors 210 may be stored in a “vector space” 202, which may refer to a mathematical space (e.g., an n-dimensional space) in which vectors are represented as points. In some cases, a distance between vectors 210 in the vector space 202 may indicate their semantic similarity (e.g., allowing for the comparison and retrieval of related data objects). As a simplified and illustrative example, each entry 225 of the database 200 may be associated with a vector 210 that corresponds to a point (e.g., a node) in a vector space 202 (e.g., a graph of the data structure). A first entry 225 with index 1 may correspond to point 1, a second entry 225 with index 2 may correspond to point 2, and so on. Points that are closer together in the vector space 202 may be relatively (e.g., semantically) similar and points that are farther away may be relatively different. For example, point 1 (e.g., index 1 in the database 200, representative of a text string, “string A”) may be relatively similar to point 3 (e.g., index 3 in the database 200, representative of an image, “Image A”) and point 4 (e.g., index 4 in the database 200, representative of an audio signal), but may be relatively different than point 2 (e.g., index 2 in the database 200, representative of data, 1, 2, 3, 4) and index 5 in the database 200, representative of a text string, “string B”).

Accessing the database 200 (e.g., a search operation) may begin with a “query,” which may refer to a request for information or data retrieval submitted to a database system. In the context of vector databases, a query (e.g., an input query, a user query) may be converted into a numerical representation, known as a “query vector,” which may then be used to search for and retrieve relevant data objects that are semantically similar to the query. Various methods or algorithms may be used to search the database 200 based on the query. For instance, a brute force method may compare a query vector with each vector 210 of the database 200, but such techniques may not be scalable. In some other examples, an algorithm, such as an approximate nearest neighbor (ANN) search, may be used to efficiently search a subset (e.g., the most relevant points) of the database 200.

As a non-limiting example, an algorithm may begin by calculating a first distance between the query vector and a first vector 210 (e.g., index 1) in the database 200. Additionally, respective distances between each vector 210 associated with the corresponding neighbor indices 215 (e.g., indices 2, 4, and 3, as indicated in the entry 225) may be calculated and compared to the first distance. The vector 210 that is a smallest distance away (e.g., 2) from the query vector may then be selected, and respective distances for the neighbor indices 215 (e.g., indices 1, 4, and 5) may be compared to the distance of the selected vector. Such a process may continue (e.g., iteratively) until a vector is selected that is closer to the query vector than each of its neighbor indices 215.

Various algorithms may be supported to manage the database 200. Some examples may include, but are not limited to, local sensitivity hashing (LSH)-based methods (e.g., simple random sampling (SRS), query-aware locality-sensitive hashing (QALSH)), group hashing (e.g., anchor graph hashing, scalable graph hashing, neighbor sensitive hashing, selective hashing), optimal product quantization, tree-based methods (e.g., fast library for approximate nearest neighbors (FLANN), Annoy), neighbor-based methods (e.g., Kgraph, small world, hierarchical navigable small worlds (HNSW), disk-based approximate nearest neighbor (DiskANN), rank cover tree), and diversified proximity graphs.

For instance, HNSW may leverage a small world phenomenon, where nodes in a graph are connected through both local and long-range links, enabling efficient navigation and search. An HNSW algorithm may construct a hierarchical structure of interconnected nodes, allowing for fast and scalable searches by employing a greedy search strategy that traverses through layers of the hierarchy to identify the nearest neighbors. Alternatively, DiskANN may address memory and computational limitations of large-scale vector databases by improving storage and retrieval (e.g., directly on a disk or other storage media). DiskANN may utilize a Vamana algorithm to reduce the time complexity of constructing relative neighborhood graphs, facilitating efficient search operations with relatively low memory and compute resources. In some examples, HNSW, DiskANN, or both may be used to enhance the performance and scalability of vector databases (e.g., a database 200), making them well-suited for managing large volumes of high-dimensional data in applications such as natural language processing and computer vision.

Some memory methods and architectures, however, may not be configured to efficiently support operations of a database 200, particularly as the scale and complexity increases. For instance, some techniques may utilize processing of a host system 105 and active communications between a memory system 110 and a host system 105 to perform the various search operations (e.g., navigation algorithms) and data access operations. Such techniques may result in relatively high latency, relatively high resource consumption, and other inefficiencies when utilizing a database 200.

In accordance with examples as disclosed herein, a system (e.g., a memory system 110, a NAND system, an SSD, an electronic system) may support techniques that enable more-efficient access operations, search operations, and data retrieval operations associated with a database 200 (e.g., stored at the system). For example, database navigation (e.g., embedding vector search) and data retrieval operations may be performed directly within a memory system 110. Additionally, or alternatively, a memory system 110 may be structured to support enhanced parallelism across multiple memory devices 130 of the system (e.g., by enabling a parallel vector search operation). For example, neighboring entries 225 in the database 200 may be stored to different memory devices 130 (e.g., associated with different channels), such that access and distance computations of each neighbor may be performed in parallel. Accordingly, the techniques herein may simplify data management of the database 200, enhancing database search speed and improving response times. Additionally, such architectures may enable efficient management techniques, supporting scalable database systems with relatively high quantities of unstructured data.

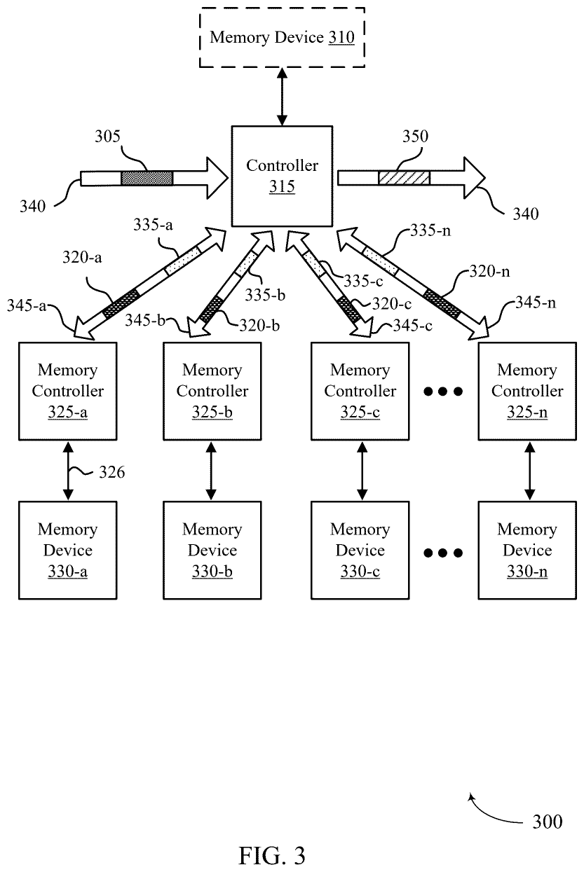

FIG. 3 shows an example of a system 300 that supports data retrieval using vector databases at a memory system in accordance with examples as disclosed herein. The system 300 may be an example of, or include, one or more components described with reference to a system 100. For example, the system 300 may include a controller 315 (e.g., a memory system controller 115, processing circuitry), a memory device 310 (e.g., a DRAM device, which may be optional), one or more memory controllers 325 (e.g., circuitry 135, processing circuitry), one or more memory devices 330 (e.g., memory devices 130, NAND devices). The controller 315 may be coupled with each memory controller 325 via a respective interface 345 (e.g., respective interfaces 122, respective channels). The controller 315 may communicate with other devices (e.g., a host system 105, a memory system 110) via an interface 340 (e.g., a physical layer (PHY) interface, a PCIe PHY interface). The system 300 may be configured to support storage of a database 200 (e.g., including one or more entries 225 associated with an index 205, a vector 210, one or more neighbor indices 215, data 220, or any combination thereof), and to implement one or more database management techniques as described herein (e.g., including with reference to FIG. 2).

In some cases, AI/ML applications (e.g., retrieval-augmented generation (RAG)) may support enhanced natural language processing (NLP) performance (e.g., by providing additional context to user inputs). Vector databases may support such AI/ML applications, and techniques that improve the storage, search, and retrieval processes within these databases may be beneficial. For example, some architectures (e.g., existing storage media architectures, SSD architectures) and database management methods (e.g., DiskANN algorithms) for vector databases may face challenges due to a reliance on constant communication between the system 300 and an external processor (e.g., a host system 105), which may lead to increased latency and slow response times. Some techniques, for example, may be based on host computational resources to perform vector search and retrieval, which may be resource-intensive and inefficient, especially when managing relatively large or unstructured datasets. Thus, as volume of unstructured data increases, the scalability of vector database systems (e.g., stored at systems 300) may be relatively inefficient and impractical.

A system 300 (e.g., a NAND system, an SSD system, an electronic system) may be configured to support various architectures and methods (e.g., including physical layout of components, storage schemes, management operations, and other aspects) designed to improve efficiency (e.g., access speed, response times, power consumption) associated with database management operations (e.g., of vector databases). In some examples, a vector index (e.g., an index 205) and the vector itself (e.g., vector 210, an embedding vector)—which may be referred to as an “index/vector pair”—may be stored to a memory device 330, and corresponding index/vector pairs of its neighbors (e.g., its neighbor indices 215) may be stored to respective different memory devices 330 (e.g., index/vector pairs and neighbors may be stored to the system 300 as page stripes). For example, an index/vector pair may be stored to the memory device 330-a, a first neighbor index/vector pair may be stored to the memory device 330-b, a second neighbor index/vector pair may be stored to the memory device 330-c, and so on.

In accordance with these and other implementations, in response to an input 305 (e.g., a query, a query vector, provided by a host), a controller 315 may initiate (e.g., trigger) a search operation (e.g., a Vamana search, an HNSW search) of a database stored at the system 300 (e.g., a database 200). During the search, the controller 315 may retrieve each vector and its neighbors concurrently (e.g., in parallel) from the memory devices 330 (e.g., via the memory controllers 325, using page parallelism). Each memory controller 325 may include processing circuitry (e.g., an FPU, an ALU, or other processing resources), which may be leveraged to perform one or more computational operations (e.g., vector distance calculations) as part of the database search. In response to an index (e.g., an approximate nearest neighbor index) being identified as a nearest index to the query vector (e.g., the input 305), the controller 315 may retrieve the data (e.g., data 220, image data, text data, audio data) associated with the nearest index and may output (e.g., communicate, transmit, transfer) the retrieved data via the interface 340 (e.g., via an output 350).

In some examples, the controller 315 may receive an input 305 (e.g., from a host system, from an application, from a user). The input 305 may include a query vector (e.g., a query, an input query, a user query, an input vector) associated with data retrieval (e.g., a request for data) from the system 300 (e.g., from a vector database stored at the system 300) and may include a numerical representation of one or more dimensions (e.g., may include a numerical entry in each dimension) of a vector space (e.g., an embedded vector, a vector 210). In some examples, the controller 315 may generate one or more addresses 320 (e.g., one or more physical addresses, of one or more memory devices 330) in response to the input 305. Each address 320 may correspond to an entry in a vector database (e.g., an entry 225, corresponding to an index 205, a vector 210, one or more neighbor indices 215, data 220, or any combination thereof). In some examples, the controller 315 may obtain the one or more addresses 320 using (e.g., based on) a logical-to-physical (L2P) address mapping (e.g., the controller 315 may obtain one or more L2P addresses from an L2P table stored or cached at the memory device 310). The controller 315 may generate the one or more addresses 320 in accordance with various techniques (e.g., random generation, deterministic generation, based on an algorithm). For example, the controller 315 may randomly generate one or more first addresses 320 (e.g., an initial guess) and may use the first address(es) 320 as a starting point for the vector search.

The controller 315 may be configured to output (e.g., transmit) one or more addresses 320 to one or more corresponding memory controllers 325 (e.g., to corresponding memory devices 330). In response to a received address 320, the one or more memory controllers 325 may be configured to perform a read operation via respective interfaces 326 (e.g., perform read on page via its associated channel). Based on the read operation of the received address, a memory controller 325 may obtain vector database information, including, for example, a vector index (e.g., an index 205), a vector (e.g., a vector 210, an embedding vector), or both.

Each memory controller 325 may include circuitry (e.g., an FPU) configured to perform various arithmetic operations (e.g., addition, subtraction, multiplication, division, of floating point values). Accordingly, the memory controllers 325 may determine (e.g., compute, calculate) a distance metric between the query vector (e.g., received via the input 305) and the vector associated with the received address 320. One or more distance metrics may be used for such distance calculations, such as a Euclidian distance calculation (e.g., Σ(x−y)²), a Manhattan distance calculation (e.g., Σ|x−y|), or a cosine similarity calculation

$$( e . g . , \frac{x \cdot y}{‖ x ‖ ‖ y ‖} = \frac{Σ {x}_{i} {y}_{i}}{Σ {x}_{i}^{2} Σ {y}_{i}^{2}} ) ,$$

among others. In some examples, the memory controller(s) 325 (e.g., the FPU) may receive an indication (e.g., from the controller 315) of a query vector and may determine the distance metrics based on receiving (or otherwise ascertaining) the indication of the query vector. The memory controller(s) 325 may (e.g., after determining the distance metric) output (e.g., transmit) a response 335 (e.g., a response to the received address 320), which may be received by the controller 315. Each response 335 may include an indication of a respective vector (e.g., an index 205) corresponding to (e.g., associated with, related to) the received address 320, a distance metric (e.g., the computed distance metric) associated with the respective vector stored at the received address 320, or both.

In some examples, such operations may be performed by one or more memory controllers 325 in parallel (e.g., concurrently, simultaneously, with one another). For example, a controller 315 may identify a first address associated with a first vector index and one or more second addresses (e.g., obtained from the memory device 310) that are associated with one or more neighbor indices of the first vector index. The set of neighboring indices (e.g., the first vector index and each or the neighbor indices) in a vector space may be stored at respective memory devices 330 (e.g., by design, to enhance parallelism). For example, a vector may be stored (e.g., the controller 315 may store the vector) at memory device 330-a, a first neighboring vector may be stored at memory device 330-b, a second neighboring may be stored at memory device 330-c, and so on. Accordingly, a nearest neighbor search algorithm may be performed relatively faster, as a given vector index as well as multiple neighbor indices may be obtained (e.g., evaluated) concurrently.

In some examples, the controller 315 may (e.g., after receiving one or more responses 335) aggregate the received distance metrics and the received index values from the memory controllers 325 and may determine a smallest distance metric (e.g., may perform a minimum distance search, may identify the vector from the search that is closest to the query vector). The controller 315 may then use the vector associated with the smallest distance metric to initiate another iteration of searching. For example, the controller 315 may obtain a first address 320 associated with the vector having the smallest distance metric (e.g., the current nearest vector to the query vector) as well as one or more second addresses 320 associated with each of its neighbor indices. The controller 315 may output the respective addresses 320 to corresponding memory controllers 325, receive the determined distance metrics, and may determine (e.g., revaluate) a smallest distance metric.

In some examples, one or more iterations of the described operations may be performed at the system 300 until the received distance metrics (e.g., from the memory controllers 325) are each greater than the current smallest distance metric (e.g., until a local minimum is identified), or until a threshold distance is satisfied, or until a threshold quantity of iterations is performed, among other criteria. Any quantity of these iterative search operations may be supported by the system 300 (e.g., a configured quantity, or as many as needed to identify the smallest distance metric). In such examples, the controller 315 may obtain data (e.g., retrieve or read the data from one or more of the memory devices 330, via one or more of the memory controllers 325) associated with the vector having the smallest distance metric (e.g., using an L2P table). In some examples, the controller 315 may generate an output 350 (e.g., a message, a signal, a transfer) that includes the obtained data (e.g., as well as the corresponding embedding vector and the corresponding vector index), and may transmit (e.g., output, send) the output 350 via the interface 340 (e.g., to a host system 105, to a processor, to an application, to a user).

As an illustrative example, the controller 315 may receive a query vector (e.g., an input 305) associated with data retrieval from the system 300. The query vector may include a numerical representation of one or more dimensions of a vector space associated with the system 300. Based on (e.g., in response to, as a function of) the query vector, the controller 315 may output an address 320-a (e.g., which may be based on a randomly generated vector index) associated with a memory device 330-a to a memory controller 325-a (e.g., to a memory device 330-a) via an interface 345-a (e.g., a first channel). In some examples, the controller 315 may obtain the address 320-a using an L2P address mapping of the system 300 (e.g., stored at the memory device 310), and the controller 315 may output the address 320-a based on obtaining the address 320-a. Although the illustrative example describes operations associated with a single address 320-a output to a single memory controller 325-a (e.g., for an initial search), the described techniques may be repeated (e.g., concurrently, simultaneously) for any quantity of one or more memory devices 330 (e.g., for each of the memory devices 330, in the initial or subsequent searches).

In some examples, the controller 315 may receive a response 335-a from the memory controller 325-a. The response 335-a may include a first indication (e.g., an index 205) of a first vector (e.g., a vector 210) corresponding to first data (e.g., data 220) associated with the address 320-a, a first distance metric corresponding to the first data, or both. In some examples, the first distance metric (which may be determined or computed by the memory controller 325-a) may be indicative of a first distance between the query vector and the first vector.

In some examples, the controller 315 may output (e.g., based on the first indication) an address 320-b associated with a memory device 330-b to a memory controller 325-b (e.g., to a memory device 330-b) via an interface 345-b (e.g., Channel 1). The controller 315 may also output (e.g., concurrent with outputting the address 320-b) an address 320-c associated with a memory device 330-c to a memory controller 325-c (e.g., to a memory device 330-c) via an interface 345-c (e.g., Channel 2). Although the subsequent outputs of addresses 320 of a subsequent search may be directed to different memory devices 330 than an initial search, the described techniques may, additionally, or alternatively, include outputs of addresses 320 to a same memory device 330 as an initial search. In some examples, based on (e.g., in response to) receiving the response 335-a, the controller 315 may obtain an address 320-b and an address 320-c (e.g., from the memory device 310, from an L2P table) based on the address 320-b and the address 320-c being associated with respective neighboring indices of the first index of the first vector in the vector space. For example, the address 320-b may correspond to a first neighbor index 215 of the vector associated with address 320-a, and the address 320-c may correspond to a second neighbor index 215 of the vector associated with the address 320-a. Although, a non-limiting example of two neighbor indices is described, the system 300 may support concurrent output of any quantity of neighbor indices (e.g., one, two, three, four, five, and so on) to one or more memory controllers 325.

In some examples, the controller 315 may receive a response 335-b from the memory controller 325-b and a response 335-c from the memory controller 325-c. The response 335-b may include a second indication (e.g., an index 205) of a second vector (e.g., a vector 210), a second distance metric corresponding to second data (e.g., data 220 of first neighbor) associated with the address 320-b, or both. The response 335-c may include a third indication (e.g., an index 205) of a third vector (e.g., a vector 210), a third distance metric corresponding to third data (e.g., data 220) associated with the address 320-b, or both. In some examples, the second distance metric may be indicative of a second distance between the query vector and the second vector, and the third distance metric may be indicative of a third distance between the query vector and the third vector.

In some examples, the controller 315 may output fourth data (e.g., via an output 350) based on the first distance metric, the second distance metric, the third distance metric, or any combination thereof. For example, the output 350 may include the first data based on (e.g., as a result of) the first distance metric being lower than the second distance metric and the third distance metric. Alternatively, the output 350 may include the second data based on the second distance metric being lower than the first distance metric and the third distance metric. In another example, the output 350 may include the third data based on the third distance metric being lower than the first distance metric and the second distance metric. In some examples, the output 350 may include a fourth indication (e.g., an index 205) of a fourth vector corresponding to the data included in the output 350, the fourth vector (e.g., a vector 210), or both.

In some examples, one or more iterations of the described operations may be performed to determine the data for the output 350 (e.g., to identify vector that most nearly approximates the query vector, to identify the data 220 that most nearly satisfies the query of input 305). For example, the controller 315 may output (e.g., prior to transmitting the output 350) an address 320-n to a memory controller 325-n (e.g., to the memory device 330-n) via an interface 345-n (e.g., Channel N). In some examples, the address 320-n may be output based on the second indication and the third indication received from the memory controller 325-b and memory controller 325-c. The controller 315 may receive (e.g., from the memory controller 325-n) a response 335-n including a fourth indication (e.g., an index 205) of a fourth vector (e.g., a vector 210), a fourth distance metric (e.g., computed by the memory controller 325-n) corresponding to data (e.g., data 220) associated with the address 320-n, or both. In some examples, the fourth distance metric may be indicative of a fourth distance between the query vector and the fourth vector. In some examples, the output 350 may include the data associated with address 320-n based on the fourth distance metric being lower than the first distance metric, the second distance metric, and the third distance metric.

The system 300 may utilize one or more storage schemes to support the parallel search operations (e.g., to accelerate vector database search, to support prefetch operations) described herein. For example, the controller 315 may store information (e.g., entries 225) for each vector and a set of nearby vectors (e.g., in a vector space, a first vector and one or more neighboring vectors, which may be determined in accordance with a nearest neighbor algorithm) to different memory devices 330 (e.g., in adjacent planes, blocks, or pages). As an illustrative example, the system 300 may receive, prior to reception of the query vector, a database entry (e.g., an entry 225) that includes an index, a vector, one or more neighbor indices (e.g., including at least a second index and a third index), and data corresponding to the index. Accordingly, the system 300 may write the index to the memory device 330-a, the second index to the memory device 330-b, and the third index to the memory device 330-c. In some examples, outputting the address 320-b and the address 320-c may be based on the writing.

Additionally, or alternatively, a combination of an index 205, a vector 210, and neighing indices 215 may be stored in physical locations of a memory device 330 that support efficient retrieval. For example, such a combination may be stored in a page 175, a block 170, or a virtual block 180 that supports parallelized or otherwise streamlined access (e.g., as an alternative to storing such a combination across physical locations that do not support such efficient access). Such techniques may therefore map portions of (e.g., an architecture of) a database 200 to storage locations of a memory device 330 to support more efficient search processing within the system 300. In some examples, data 220 may also be included in such a combination (e.g., stored with other portions of a database 200 in a page 175, a block 170, or a virtual block 180 that supports access parallelization or other efficiencies), which may support prefetching data 220 or otherwise preparing access to data 220, which may be provided before identifying a closest vector 210 for a given search.

The techniques described herein may support various improvements to one or more searching algorithms (e.g., HSNW). For example, a first step of an algorithm may include populating an empty list of candidates (e.g., neighbor candidates, stored across various memory devices 330). In each subsequent operation, the list may be updated with identified neighbors. In some examples, one or more of the neighbor entries 225 (e.g., neighbor indices 215) may be prefetched (e.g., at the memory controller 325) during the algorithm, as at least some of these neighbors may be evaluated during a subsequent retrieval, which may reduce processing time associated with the search. Additionally, or alternatively, because one or more neighbor entries 225 may be known, storage schemes may be implemented to store the neighbor entries together (e.g., storing neighbor indices 215 within a same page 175 or across a super page, such as a combination of pages 175).

In some examples, with a configuration to support one or more vector database storage, search, and retrieval operations described herein, a system 300 may provide improved performance, increased robustness, reduced cost, and reduced power consumption. For example, multiple iterations of search algorithms (e.g., HSNW) may be parallelized across multiple systems 300 and a host system 105 may aggregate the results, which may reduce search times. Additionally, or alternatively, a system 300 may improve processing efficiency based on parallelization of independent word line (iWL) commands, multiplane parallelization, or channel parallelization. Additionally, or alternatively, a system 300 (e.g., one or more memory device 330) may be implemented with a page size, one or more channel sizes, or one or more drive sizes based on the vector and neighborhood size. A system 300 also may implement multiple distancing metrics and may leverage any search algorithm, providing flexibility and adaptability to various applications. In some examples, the system 300 may leverage a combination of SLC, TLC, and QLC spaces based on read and write performance (e.g., vectors 210 and neighbor indices 215 may be stored in accordance with an SLC configuration to support rapid searches, data 220 may be stored in accordance with a QLC configuration to support relatively high storage density and capacity).

Thus, in accordance with one or more aspects disclosed herein, a system 300 may simplify data management of relatively large databases (e.g., vector databases, unstructured databases, and other AI/ML application databases), reducing the complexity and processing overhead (e.g., associated with handling high-dimensional vector embeddings). Further, the architecture of a system 300 may enable more efficient and scalable database systems, which may support AI/ML applications and other data intensive applications that benefit from fast and accurate retrieval of data (e.g., semantically similar data in response to a query).

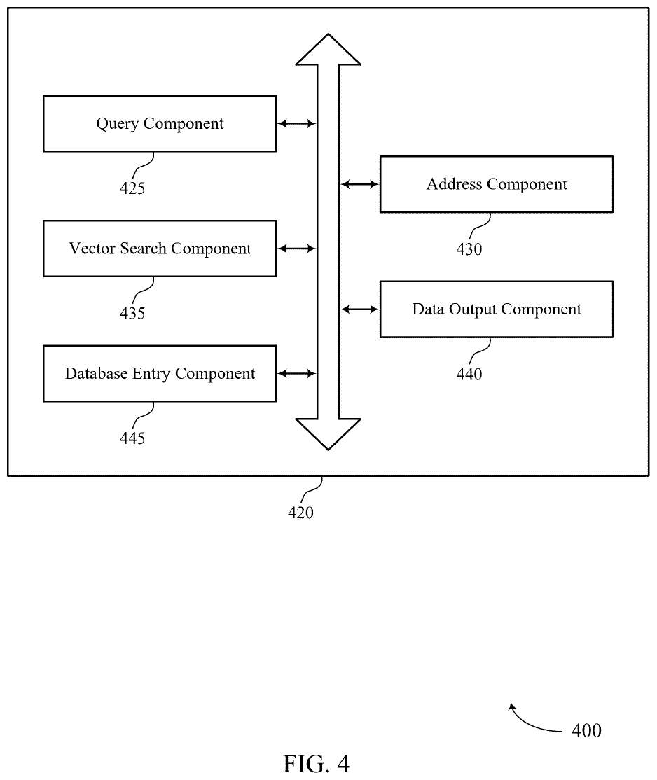

FIG. 4 shows a block diagram 400 of processing circuitry 420 that supports data retrieval using vector databases at a memory system in accordance with examples as disclosed herein. The processing circuitry 420 may be an example of aspects of (e.g., may be included in) a memory system as described with reference to FIGS. 1 through 3 (e.g., of a memory system 110, such as a memory system controller 115, of a system 300, such as a controller 315), and may be operable to couple with one or more memory devices (e.g., a plurality of memory devices, memory device(s) 130, memory device(s) 330). The processing circuitry 420, or various components thereof, may be an example of means for performing (e.g., to cause the processing circuitry 420 to perform) various aspects of data retrieval using vector databases at a memory system as described herein. For example, the processing circuitry 420 may include a query component 425, an address component 430, a vector search component 435, a data output component 440, a database entry component 445, or any combination thereof. Each of these components, or components of subcomponents thereof (e.g., one or more processors, one or more memories), may communicate, directly or indirectly, with one another (e.g., via one or more buses).

The query component 425 may be configured as or otherwise support a means for receiving (e.g., from a host system 105 or host system controller 106 that is coupled with the processing circuitry 420) a query vector associated with data retrieval from a memory system (e.g., a memory system that includes or is coupled with the processing circuitry 420, a memory system 110, a system 300), the query vector including a numerical representation of one or more dimensions of a vector space associated with the memory system. The address component 430 may be configured as or otherwise support a means for outputting a first address associated with a first memory device of the memory system (e.g., a first memory device coupled with the processing circuitry 420, a first memory device 130, a first memory device 330) based at least in part on the query vector. The vector search component 435 may be configured as or otherwise support a means for receiving a first indication of a first vector and a first distance metric corresponding to first data associated with the first address, where the first distance metric is indicative of a first distance in the vector space between the query vector and the first vector. In some examples, the address component 430 may be configured as or otherwise support a means for outputting, based at least in part on receiving the first indication, a second address associated with a second memory device of the memory system (e.g., a second memory device coupled with the processing circuitry 420, a second memory device 130, a second memory device 330), and a third address associated with a third memory device of the memory system (e.g., a third memory device coupled with the processing circuitry 420, a third memory device 130, a third memory device 330). The second memory device or the third memory device, in some examples, may be the same as the first memory device or may be different from the first memory device. In some examples, the vector search component 435 may be configured as or otherwise support a means for receiving a second indication of a second vector and a second distance metric corresponding to second data associated with the second address, where the second distance metric is indicative of a second distance between the query vector and the second vector. In some examples, the vector search component 435 may be configured as or otherwise support a means for receiving a third indication of a third vector and a third distance metric corresponding to third data associated with the third address from the third memory device, where the third distance metric is indicative of a third distance between the query vector and the third vector. The data output component 440 may be configured as or otherwise support a means for outputting fourth data based at least in part on the second distance metric and the third distance metric.

In some examples, the fourth data includes the first data based at least in part on the first distance metric being lower than the second distance metric and the third distance metric, the second data based at least in part on the second distance metric being lower than the first distance metric and the third distance metric, or the third data based at least in part on the third distance metric being lower than the first distance metric and the second distance metric.

In some examples, to support outputting the second address and the third address, the address component 430 may be configured as or otherwise support a means for outputting the second address to the second memory device. In some examples, to support outputting the second address and the third address, the address component 430 may be configured as or otherwise support a means for outputting, concurrent with outputting the second address, the third address to the third memory device.

In some examples, the address component 430 may be configured as or otherwise support a means for obtaining the second address and the third address, in response to reception of the first indication, based at least in part on the second address and the third address being associated with respective neighboring indices of a first index of the first vector in the vector space.

In some examples, the address component 430 may be configured as or otherwise support a means for outputting, prior to outputting the fourth data, a fourth address based at least in part on the second indication and the third indication. In some examples, the vector search component 435 may be configured as or otherwise support a means for receiving a fourth indication of a fourth vector and a fourth distance metric corresponding to the fourth data, where the fourth distance metric is indicative of a fourth distance between the query vector and the fourth vector, and where output of the fourth data is based at least in part on the fourth distance metric being lower than the first distance metric, the second distance metric, and the third distance metric.

In some examples, the first address and the first memory device are associated with a first memory controller of a plurality of memory controllers. In some examples, the second address and the second memory device are associated with a second memory controller of the plurality of memory controllers. In some examples, the third address and the third memory device are associated with a third memory controller of the plurality of memory controllers.

In some examples, the first distance metric is determined by a first memory controller. In some examples, the second distance metric is determined by a second memory controller, and the third distance metric is determined by a third memory controller.

In some examples, the first indication includes a first index of the vector space, the second indication includes a second index of the vector space, and the third indication includes a third index of the vector space.

In some examples, the database entry component 445 may be configured as or otherwise support a means for receiving, prior to reception of the query vector, a database entry including the first index, the first vector, a plurality of neighbor indices including at least the second index and the third index, and data corresponding to the first index. In some examples, the database entry component 445 may be configured as or otherwise support a means for writing the first index to the first memory device, the second index to the second memory device, and the third index to the third memory device, where output of the second address and the third address is based at least in part on the writing.

In some examples, the vector search component 435 may be configured as or otherwise support a means for obtaining the first address using a logical-to-physical address mapping of the memory system, where output of the first address is based at least in part on obtaining the first address.

In some examples, to support outputting the fourth data, the data output component 440 may be configured as or otherwise support a means for outputting, along with the fourth data, a fourth indication of a fourth vector corresponding to the fourth data and the fourth vector.

In some examples, the described functionality of the processing circuitry 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the processing circuitry 420, or a memory system that includes the processing circuitry 420, to perform one or more operations. In some examples, the described functionality of the processing circuitry 420, or various components thereof, may be implemented at least in part by instructions (e.g., stored in memory, non-transitory computer-readable medium) executable by such at least one processor to cause the processing circuitry 420, or a memory system that includes the processing circuitry 420, to perform one or more operations.

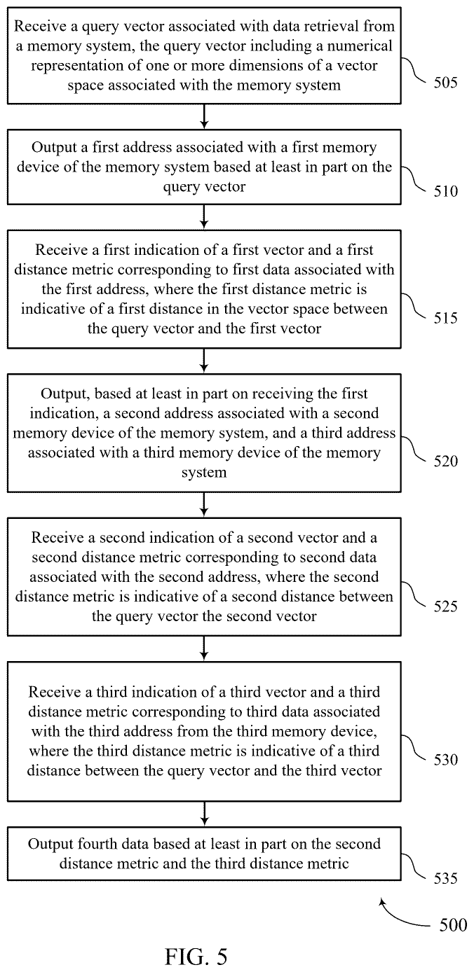

FIG. 5 shows a flowchart illustrating a method 500 that supports data retrieval using vector databases at a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method 500 may include receiving a query vector associated with data retrieval from a memory system, the query vector including a numerical representation of one or more dimensions of a vector space associated with the memory system. In some examples, aspects of the operations of 505 may be performed by a query component 425.

At 510, the method 500 may include outputting a first address associated with a first memory device of the memory system based at least in part on the query vector. In some examples, aspects of the operations of 510 may be performed by an address component 430.

At 515, the method 500 may include receiving a first indication of a first vector and a first distance metric corresponding to first data associated with the first address, where the first distance metric is indicative of a first distance in the vector space between the query vector and the first vector. In some examples, aspects of the operations of 515 may be performed by a vector search component 435.

At 520, the method 500 may include outputting, based at least in part on receiving the first indication, a second address associated with a second memory device of the memory system, and a third address associated with a third memory device of the memory system. In some examples, aspects of the operations of 520 may be performed by an address component 430.

At 525, the method 500 may include receiving a second indication of a second vector and a second distance metric corresponding to second data associated with the second address, where the second distance metric is indicative of a second distance between the query vector and the second vector. In some examples, aspects of the operations of 525 may be performed by a vector search component 435.

At 530, the method 500 may include receiving a third indication of a third vector and a third distance metric corresponding to third data associated with the third address from the third memory device, where the third distance metric is indicative of a third distance between the query vector and the third vector. In some examples, aspects of the operations of 530 may be performed by a vector search component 435.

At 535, the method 500 may include outputting fourth data based at least in part on the second distance metric and the third distance metric. In some examples, aspects of the operations of 535 may be performed by a data output component 440.

Although the operations of 525 and 530 may illustrate an example of receiving indications of vectors associated with two memory devices, the described techniques may be implemented across any quantity of one or more memory devices. Additionally, or alternatively, although the operations of 520 through 530 may illustrate an example of a single search iteration, the described techniques may be implemented for any quantity of one or more iterations. Additionally, or alternatively, although the operations of 520 through 530 may illustrate an example of an iteration that is initially implemented via a single memory device (e.g., in accordance with the operations of 520), the described techniques (e.g., of 520, and responsive operations of 525 and 530) may be performed (e.g., in parallel) in accordance with an iteration that is initially implemented across multiple memory devices. Any one or more of such techniques, or variations thereof, may be implemented to support the output of data in accordance with the operations of 535.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a query vector associated with data retrieval from a memory system, the query vector including a numerical representation of one or more dimensions of a vector space associated with the memory system; outputting a first address associated with a first memory device of the memory system based at least in part on the query vector; receiving a first indication of a first vector and a first distance metric corresponding to first data associated with the first address, where the first distance metric is indicative of a first distance in the vector space between the query vector and the first vector; outputting, based at least in part on receiving the first indication, a second address associated with a second memory device of the memory system, and a third address associated with a third memory device of the memory system; receiving a second indication of a second vector and a second distance metric corresponding to second data associated with the second address, where the second distance metric is indicative of a second distance between the query vector and the second vector; receiving a third indication of a third vector and a third distance metric corresponding to third data associated with the third address from the third memory device, where the third distance metric is indicative of a third distance between the query vector and the third vector; and outputting fourth data based at least in part on the second distance metric and the third distance metric.

Aspect 2: The method, apparatus, or non-transitory computer-readable medium of aspect 1, where the fourth data includes the first data based at least in part on the first distance metric being lower than the second distance metric and the third distance metric, the second data based at least in part on the second distance metric being lower than the first distance metric and the third distance metric, or the third data based at least in part on the third distance metric being lower than the first distance metric and the second distance metric.

Aspect 3: The method, apparatus, or non-transitory computer-readable medium of any of aspects 1 through 2, where outputting the second address and the third address includes operations, features, circuitry, logic, means, or instructions, or any combination thereof for outputting the second address to the second memory device and outputting, concurrent with outputting the second address, the third address to the third memory device.

Aspect 4: The method, apparatus, or non-transitory computer-readable medium of any of aspects 1 through 3, further including operations, features, circuitry, logic, means, or instructions, or any combination thereof for obtaining the second address and the third address, in response to reception of the first indication, based at least in part on the second address and the third address being associated with respective neighboring indices of a first index of the first vector in the vector space.

Aspect 5: The method, apparatus, or non-transitory computer-readable medium of any of aspects 1 through 4, further including operations, features, circuitry, logic, means, or instructions, or any combination thereof for outputting, prior to outputting the fourth data, a fourth address based at least in part on the second indication and the third indication and receiving a fourth indication of a fourth vector and a fourth distance metric corresponding to the fourth data, where the fourth distance metric is indicative of a fourth distance between the query vector and the fourth vector, and where output of the fourth data is based at least in part on the fourth distance metric being lower than the first distance metric, the second distance metric, and the third distance metric.

Aspect 6: The method, apparatus, or non-transitory computer-readable medium of any of aspects 1 through 5, where the first address and the first memory device are associated with a first memory controller of a plurality of memory controllers; the second address and the second memory device are associated with a second memory controller of the plurality of memory controllers; and the third address and the third memory device are associated with a third memory controller of the plurality of memory controllers.

Aspect 7: The method, apparatus, or non-transitory computer-readable medium of aspect 6, where the first distance metric is determined by a first memory controller and the second distance metric is determined by a second memory controller, and the third distance metric is determined by a third memory controller.

Aspect 8: The method, apparatus, or non-transitory computer-readable medium of any of aspects 1 through 7, where the first indication includes a first index of the vector space, the second indication includes a second index of the vector space, and the third indication includes a third index of the vector space.

Aspect 9: The method, apparatus, or non-transitory computer-readable medium of aspect 8, further including operations, features, circuitry, logic, means, or instructions, or any combination thereof for receiving, prior to reception of the query vector, a database entry including the first index, the first vector, a plurality of neighbor indices including at least the second index and the third index, and data corresponding to the first index and writing the first index to the first memory device, the second index to the second memory device, and the third index to the third memory device, where output of the second address and the third address is based at least in part on the writing.

Aspect 10: The method, apparatus, or non-transitory computer-readable medium of any of aspects 1 through 9, further including operations, features, circuitry, logic, means, or instructions, or any combination thereof for obtaining the first address using a logical-to-physical address mapping of the memory system, where output of the first address is based at least in part on obtaining the first address.

Aspect 11: The method, apparatus, or non-transitory computer-readable medium of any of aspects 1 through 10, where outputting the fourth data includes operations, features, circuitry, logic, means, or instructions, or any combination thereof for outputting, along with the fourth data, a fourth indication of a fourth vector corresponding to the fourth data and the fourth vector.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 12: An apparatus, including: processing circuitry operable to couple with a plurality of memory devices of a memory system, the processing circuitry configured to cause the apparatus to: receive a query vector associated with data retrieval from the memory system, the query vector including a numerical representation of one or more dimensions of a vector space associated with the memory system; output a first address associated with a first memory device of the plurality of memory devices based at least in part on the query vector; receive a first indication of a first vector and a first distance metric corresponding to first data associated with the first address, where the first distance metric is indicative of a first distance between the query vector and the first vector; output, based at least in part on the first indication, a second address associated with a second memory device of the plurality of memory devices and a third address associated with a third memory device of the plurality of memory devices; receive a second indication of a second vector and a second distance metric corresponding to second data associated with the second address, where the second distance metric is indicative of a second distance between the query vector and the second vector; receive a third indication of a third vector and a third distance metric corresponding to third data associated with the third address from the third memory device, where the third distance metric is indicative of a third distance between the query vector and the third vector; and output fourth data based at least in part on the second distance metric and the third distance metric.

Aspect 13: The apparatus of aspect 12, where the fourth data includes: the first data based at least in part on the first distance metric being lower than the second distance metric and the third distance metric, the second data based at least in part on the second distance metric being lower than the first distance metric and the third distance metric, or the third data based at least in part on the third distance metric being lower than the first distance metric and the second distance metric.

Aspect 14: The apparatus of any of aspects 12 through 13, where, to output the second address and the third address, the processing circuitry is configured to cause the apparatus to: output the second address to the second memory device; and output, concurrent with output of the second address, the third address to the third memory device.

Aspect 15: The apparatus of any of aspects 12 through 14, where the processing circuitry is further configured to cause the apparatus to: obtain the second address and the third address, in response to reception of the first indication, based at least in part on the second address and the third address being associated with respective neighboring indices of a first index of the first vector in the vector space.

Aspect 16: The apparatus of any of aspects 12 through 15, where the processing circuitry is further configured to cause the apparatus to: output, prior to output of the fourth data, a fourth address based at least in part on the second indication and the third indication; and receive a fourth indication of a fourth vector and a fourth distance metric corresponding to the fourth data, where the fourth distance metric is indicative of a fourth distance between the query vector and the fourth vector, and where output of the fourth data is based at least in part on the fourth distance metric being lower than the first distance metric, the second distance metric, and the third distance metric.

Aspect 17: The apparatus of any of aspects 12 through 16, where: a plurality of memory controllers, each memory controller of the plurality of memory controllers being associated a respective set of one or more memory devices of the plurality of memory devices, where: the first address and the first memory device are associated with a first memory controller of the plurality of memory controllers, the second address and the second memory device are associated with a second memory controller of the plurality of memory controllers, and the third address and the third memory device are associated with a third memory controller of the plurality of memory controllers.

Aspect 18: The apparatus of aspect 17, where: the first distance metric is determined by the first memory controller, the second distance metric is determined by the second memory controller, and the third distance metric is determined by the third memory controller.

Aspect 19: The apparatus of any of aspects 12 through 18, where the first indication includes a first index of the vector space, the second indication includes a second index of the vector space, and the third indication includes a third index of the vector space.

Aspect 20: The apparatus of aspect 19, where the processing circuitry is further configured to cause the apparatus to: receive, prior to reception of the query vector, a database entry including the first index, the first vector, a plurality of neighbor indices including at least the second index and the third index, and data corresponding to the first index; and write the first index to the first memory device, the second index to the second memory device, and the third index to the third memory device, where output of the second address and the third address is based at least in part on the writing.

Aspect 21: The apparatus of any of aspects 12 through 20, where the processing circuitry is further configured to cause the apparatus to: obtain the first address using a logical-to-physical address mapping of the memory system, where output of the first address is based at least in part on obtaining the first address.

Aspect 22: The apparatus of any of aspects 12 through 21, where, to output the fourth data, the processing circuitry is configured to cause the apparatus to: output, along with the fourth data, a fourth indication of a fourth vector corresponding to the fourth data and the fourth vector.

An apparatus is described. The following provides an overview of aspects of the apparatus as described herein:

Aspect 23: A memory system, including: a plurality of memory devices; and processing circuitry coupled with the plurality of memory devices and configured to cause the memory system to: receive, at the memory system, a query vector associated with data retrieval from the memory system, the query vector including a numerical representation of one or more dimensions of a vector space associated with the memory system; output a first address associated with a first memory device of the plurality of memory devices based at least in part on the query vector; receive a first indication of a first vector and a first distance metric corresponding to first data associated with the first address, where the first distance metric is indicative of a first distance between the query vector and the first vector; output, based at least in part on the first indication, a second address associated with a second memory device of the plurality of memory devices and a third address associated with a third memory device of the plurality of memory devices; receive a second indication of a second vector and a second distance metric corresponding to second data associated with the second address, where the second distance metric is indicative of a second distance between the query vector and the second vector; receive a third indication of a third vector and a third distance metric corresponding to third data associated with the third address from the third memory device, where the third distance metric is indicative of a third distance between the query vector and the third vector; and output, from the memory system, fourth data based at least in part on the second distance metric and the third distance metric.

Aspect 24: The memory system of aspect 23, where the fourth data includes: the first data based at least in part on the first distance metric being lower than the second distance metric and the third distance metric, the second data based at least in part on the second distance metric being lower than the first distance metric and the third distance metric, or the third data based at least in part on the third distance metric being lower than the first distance metric and the second distance metric.

Aspect 25: The memory system of any of aspects 23 through 24, where, to output the second address and the third address, the processing circuitry is configured to cause the memory system to: output the second address to the second memory device; and output, concurrent with output of the second address, the third address to the third memory device.

Aspect 26: The memory system of any of aspects 23 through 25, where the processing circuitry is further configured to cause the memory system to: obtain the second address and the third address, in response to reception of the first indication, based at least in part on the second address and the third address being associated with respective neighboring indices of a first index of the first vector in the vector space.

Aspect 27: The memory system of any of aspects 23 through 26, where the processing circuitry is further configured to cause the memory system to: output, prior to output of the fourth data, a fourth address based at least in part on the second indication and the third indication; and receive a fourth indication of a fourth vector and a fourth distance metric corresponding to the fourth data, where the fourth distance metric is indicative of a fourth distance between the query vector and the fourth vector, and where output of the fourth data is based at least in part on the fourth distance metric being lower than the first distance metric, the second distance metric, and the third distance metric.

Aspect 28: The memory system of any of aspects 23 through 27, further including: a plurality of memory controllers, each memory controller of the plurality of memory controllers being associated a respective set of one or more memory devices of the plurality of memory devices, where: the first address and the first memory device are associated with a first memory controller of the plurality of memory controllers, the second address and the second memory device are associated with a second memory controller of the plurality of memory controllers, and the third address and the third memory device are associated with a third memory controller of the plurality of memory controllers.

Aspect 29: The memory system of aspect 28, where: the first distance metric is determined by the first memory controller, the second distance metric is determined by the second memory controller, and the third distance metric is determined by the third memory controller.

Aspect 30: The memory system of any of aspects 23 through 29, where the first indication includes a first index of the vector space, the second indication includes a second index of the vector space, and the third indication includes a third index of the vector space.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus, comprising:
processing circuitry operable to couple with a plurality of memory devices of a memory system, the processing circuitry configured to cause the apparatus to:
receive a query vector associated with data retrieval from the memory system, the query vector comprising a numerical representation of one or more dimensions of a vector space associated with the memory system;
output a first address associated with a first memory device of the plurality of memory devices based at least in part on the query vector;
receive a first indication of a first vector and a first distance metric corresponding to first data associated with the first address, wherein the first distance metric is indicative of a first distance between the query vector and the first vector;
output, based at least in part on the first indication, a second address associated with a second memory device of the plurality of memory devices and a third address associated with a third memory device of the plurality of memory devices;
receive a second indication of a second vector and a second distance metric corresponding to second data associated with the second address, wherein the second distance metric is indicative of a second distance between the query vector and the second vector;
receive a third indication of a third vector and a third distance metric corresponding to third data associated with the third address from the third memory device, wherein the third distance metric is indicative of a third distance between the query vector and the third vector; and
output fourth data based at least in part on the second distance metric and the third distance metric.

2. The apparatus of claim 1, wherein the fourth data comprises:
the first data based at least in part on the first distance metric being lower than the second distance metric and the third distance metric,
the second data based at least in part on the second distance metric being lower than the first distance metric and the third distance metric, or
the third data based at least in part on the third distance metric being lower than the first distance metric and the second distance metric.

3. The apparatus of claim 1, wherein, to output the second address and the third address, the processing circuitry is configured to cause the apparatus to:
output the second address to the second memory device; and
output, concurrent with output of the second address, the third address to the third memory device.

4. The apparatus of claim 1, wherein the processing circuitry is further configured to cause the apparatus to:
obtain the second address and the third address, in response to reception of the first indication, based at least in part on the second address and the third address being associated with respective neighboring indices of a first index of the first vector in the vector space.

5. The apparatus of claim 1, wherein the processing circuitry is further configured to cause the apparatus to:
output, prior to output of the fourth data, a fourth address based at least in part on the second indication and the third indication; and
receive a fourth indication of a fourth vector and a fourth distance metric corresponding to the fourth data, wherein the fourth distance metric is indicative of a fourth distance between the query vector and the fourth vector, and wherein output of the fourth data is based at least in part on the fourth distance metric being lower than the first distance metric, the second distance metric, and the third distance metric.

6. The apparatus of claim 1, further comprising:
a plurality of memory controllers, each memory controller of the plurality of memory controllers being associated with a respective set of one or more memory devices of the plurality of memory devices, wherein:
the first address and the first memory device are associated with a first memory controller of the plurality of memory controllers,
the second address and the second memory device are associated with a second memory controller of the plurality of memory controllers, and
the third address and the third memory device are associated with a third memory controller of the plurality of memory controllers.

7. The apparatus of claim 6, wherein:
the first distance metric is determined by the first memory controller,
the second distance metric is determined by the second memory controller, and
the third distance metric is determined by the third memory controller.

8. The apparatus of claim 1, wherein the first indication comprises a first index of the vector space, the second indication comprises a second index of the vector space, and the third indication comprises a third index of the vector space.

9. The apparatus of claim 8, wherein the processing circuitry is further configured to cause the apparatus to:
receive, prior to reception of the query vector, a database entry comprising the first index, the first vector, a plurality of neighbor indices including at least the second index and the third index, and data corresponding to the first index; and
write the first index to the first memory device, the second index to the second memory device, and the third index to the third memory device, wherein output of the second address and the third address is based at least in part on the writing.

10. The apparatus of claim 1, wherein the processing circuitry is further configured to cause the apparatus to:
obtain the first address using a logical-to-physical address mapping of the memory system, wherein output of the first address is based at least in part on obtaining the first address.

11. The apparatus of claim 1, wherein, to output the fourth data, the processing circuitry is configured to cause the apparatus to:
output, along with the fourth data, a fourth indication of a fourth vector corresponding to the fourth data and the fourth vector.

12. A memory system, comprising:
a plurality of memory devices; and
processing circuitry coupled with the plurality of memory devices and configured to cause the memory system to:
receive, at the memory system, a query vector associated with data retrieval from the memory system, the query vector comprising a numerical representation of one or more dimensions of a vector space associated with the memory system;
output a first address associated with a first memory device of the plurality of memory devices based at least in part on the query vector;
receive a first indication of a first vector and a first distance metric corresponding to first data associated with the first address, wherein the first distance metric is indicative of a first distance between the query vector and the first vector;
output, based at least in part on the first indication, a second address associated with a second memory device of the plurality of memory devices and a third address associated with a third memory device of the plurality of memory devices;
receive a second indication of a second vector and a second distance metric corresponding to second data associated with the second address, wherein the second distance metric is indicative of a second distance between the query vector and the second vector;
receive a third indication of a third vector and a third distance metric corresponding to third data associated with the third address from the third memory device, wherein the third distance metric is indicative of a third distance between the query vector and the third vector; and
output, from the memory system, fourth data based at least in part on the second distance metric and the third distance metric.

13. The memory system of claim 12, wherein the fourth data comprises:
the first data based at least in part on the first distance metric being lower than the second distance metric and the third distance metric,
the second data based at least in part on the second distance metric being lower than the first distance metric and the third distance metric, or
the third data based at least in part on the third distance metric being lower than the first distance metric and the second distance metric.

14. The memory system of claim 12, wherein, to output the second address and the third address, the processing circuitry is configured to cause the memory system to:
output the second address to the second memory device; and
output, concurrent with output of the second address, the third address to the third memory device.

15. The memory system of claim 12, wherein the processing circuitry is further configured to cause the memory system to:
obtain the second address and the third address, in response to reception of the first indication, based at least in part on the second address and the third address being associated with respective neighboring indices of a first index of the first vector in the vector space.

16. The memory system of claim 12, wherein the processing circuitry is further configured to cause the memory system to:
output, prior to output of the fourth data, a fourth address based at least in part on the second indication and the third indication; and
receive a fourth indication of a fourth vector and a fourth distance metric corresponding to the fourth data, wherein the fourth distance metric is indicative of a fourth distance between the query vector and the fourth vector, and wherein output of the fourth data is based at least in part on the fourth distance metric being lower than the first distance metric, the second distance metric, and the third distance metric.

17. The memory system of claim 12, further comprising:
a plurality of memory controllers, each memory controller of the plurality of memory controllers being associated with a respective set of one or more memory devices of the plurality of memory devices, wherein:
the first address and the first memory device are associated with a first memory controller of the plurality of memory controllers,
the second address and the second memory device are associated with a second memory controller of the plurality of memory controllers, and
the third address and the third memory device are associated with a third memory controller of the plurality of memory controllers.

18. The memory system of claim 17, wherein:
the first distance metric is determined by the first memory controller,
the second distance metric is determined by the second memory controller, and
the third distance metric is determined by the third memory controller.

19. The memory system of claim 12, wherein the first indication comprises a first index of the vector space, the second indication comprises a second index of the vector space, and the third indication comprises a third index of the vector space.

20. A method, comprising:
receiving a query vector associated with data retrieval from a memory system, the query vector comprising a numerical representation of one or more dimensions of a vector space associated with the memory system;
outputting a first address associated with a first memory device of the memory system based at least in part on the query vector;
receiving a first indication of a first vector and a first distance metric corresponding to first data associated with the first address, wherein the first distance metric is indicative of a first distance in the vector space between the query vector and the first vector;
outputting, based at least in part on receiving the first indication, a second address associated with a second memory device of the memory system, and a third address associated with a third memory device of the memory system;
receiving a second indication of a second vector and a second distance metric corresponding to second data associated with the second address, wherein the second distance metric is indicative of a second distance between the query vector and the second vector;
receiving a third indication of a third vector and a third distance metric corresponding to third data associated with the third address from the third memory device, wherein the third distance metric is indicative of a third distance between the query vector and the third vector; and
outputting fourth data based at least in part on the second distance metric and the third distance metric.

21. The method of claim 20, wherein the fourth data comprises:
the first data based at least in part on the first distance metric being lower than the second distance metric and the third distance metric,
the second data based at least in part on the second distance metric being lower than the first distance metric and the third distance metric, or
the third data based at least in part on the third distance metric being lower than the first distance metric and the second distance metric.

22. The method of claim 20, wherein outputting the second address and the third address comprises:
outputting the second address to the second memory device; and
outputting, concurrent with outputting the second address, the third address to the third memory device.
